(19) United States
(12) Patent Application Publication
(10) Pub. No.: US 2012/0001957 A1
(43) Pub. Date: Jan. 5, 2012

(54) ELECTROPHORETIC DISPLAY AND DRIVING METHOD THEREOF

(75) Inventors: Chun-Ting Liu, Hsinchu County (TW); Hsu-Ping Tseng, Hsinchu County (TW); Chi-Mao Hung, Hsinchu City (TW); Wei-Min Sun, Taipei City (TW); Wen-Pin Chiu, Taoyuan County (TW); Pei-Lin Tien, Taichung City (TW); Yan-Liang Wu, Kaohsiung County (TW); Ying Hua Hsu, (US)

(73) Assignee: SIPIX TECHNOLOGY INC., Taoyuan County (TW)

(21) Appl. No.: 13/172,844

(22) Filed: Jun. 30, 2011

(30) Foreign Application Priority Data
Jun. 30, 2010 (TW) 99121478

(51) Int. Cl. G09G 5/10; G09G 3/34

(52) U.S. Cl. 345/690; 345/107

(57) ABSTRACT

An electrophoretic display and a driving method thereof are provided. The electrophoretic display includes a display panel, a storage unit and a timing controller. The display panel has a plurality of sub pixels. The storage unit stores a plurality of sets of multiple-grayscale driving waveforms, in which the driving voltage scales of driving waveforms corresponding to a same grayscale in the sets of multiple-grayscale driving waveforms are different from each other. The timing controller is coupled to the storage unit and the display panel and receives an image signal, and when the image signal transmits a multiple-grayscale frame, the timing controller sequentially adopts the sets of multiple-grayscale driving waveforms to drive the sub pixels.

### CROSS-REFERENCE TO RELATED APPLICATION

This application claims the priority benefit of Taiwan application serial no. 99121478, filed on Jun. 30, 2010. The entirety of the above-mentioned patent application is hereby incorporated by reference herein and made a part of this specification.

### BACKGROUND OF THE INVENTION

1. Field of the Invention

The invention generally relates to a display, and more particularly, to an electrophoretic display and a driving method thereof.

2. Description of Related Art

In recent years, various display techniques have continuously flourished. After durable researches and developments, many display products, such as electrophoretic display, liquid crystal display, plasma display and organic light emitting diode display, have been gradually commercialized and used in display devices with various sizes and various areas. Along with the more popular applications of the portable electronic products, the flexible display (for example, e-paper and e-book) has gradually attracted the market. In general speaking, in order to display, the e-paper and e-book adopt electrophoretic display technique. Taking the e-book as an example, the sub pixels thereof are mainly composed of electrophoretic fluid s with different colors (for example, red, green and blue) and white charged particles doped in the electrophoretic fluid s. An applied voltage can drive the white charged particles to move, so that each sub pixel respectively displays black, white, red, green, blue or different color tunes.

Among the currently available techniques, an electrophoretic display mostly utilizes the reflection of an external light source to realize the display. In more details, the colors of the employed electrophoretic fluid s determine the displayed colors each sub pixel can provide, in which a driving waveform is used to drive the white charged particles or black charged particles doped in the electrophoretic fluid s, so that each sub pixel can display a desired grayscale, and the displayed grayscale of each sub pixel is related to the scale of the driving voltage over the non-driving voltage in the driving waveform.

According to the depiction above, different driving waveforms for driving sub pixels can produce different grayscales and the different driving waveforms can be seen as a same set of driving waveforms. The size of the set of driving waveforms is related to the scope of the grayscales the sub pixels can display. Although the set of driving waveforms is able to drive the sub pixels to display all the grayscales, however it thereby constrains the display effect of the sub pixels. In particular, it is unable to provide a finer display frame.

### SUMMARY OF THE INVENTION

Accordingly, the invention is directed to an electrophoretic display able to produce a special dithering effect and provide finer frames.

The invention is also directed to a driving method of an electrophoretic display able to make frame displaying more smooth.

The invention provides an electrophoretic display, which includes a display panel, a storage unit and a timing controller. The display panel has a plurality of sub pixels. The storage unit stores a plurality of sets of multiple-grayscale driving waveforms, in which the driving voltage scales of driving waveforms corresponding to a same grayscale in the sets of multiple-grayscale driving waveforms are different from each other. The timing controller is coupled to the storage unit and the display panel and receives an image signal. When the image signal transmits a multiple-grayscale frame, the timing controller sequentially adopts the sets of multiple-grayscale driving waveforms to drive the sub pixels.

In an embodiment of the invention, a plurality of sub pixels adjacent to each other along a first direction in the above-mentioned sub pixels are driven by using a same set of multiple-grayscale driving waveforms, in which the first direction can be a vertical direction or a horizontal direction.

In an embodiment of the invention, each of the above-mentioned sub pixels and the adjacent sub pixels are driven by using different sets of multiple-grayscale driving waveforms.

In an embodiment of the invention, when the image signal transmits a two-grayscale frame, the above-mentioned timing controller adopts a set of two-grayscale driving waveforms stored in the storage unit to drive the sub pixels.

In an embodiment of the invention, the above-mentioned timing controller includes an analysis unit and a dithering unit. The analysis unit receives the image signal for judging whether the image signal transmits a multiple-grayscale frame or not. The dithering unit is coupled to the analysis unit. When the image signal transmits a multiple-grayscale frame, the dithering unit sequentially adopts the sets of multiple-grayscale driving waveforms to drive the sub pixels; when the image signal transmits a two-grayscale frame, the dithering unit adopts the set of two-grayscale driving waveforms to drive the sub pixels.

In an embodiment of the invention, the above-mentioned, the electrophoretic display further includes a signal processing unit coupled to the timing controller and receiving a video signal so as to produce the image signal according to the video signal.

The invention also provides a driving method of an electrophoretic display, which includes following steps: receiving an image signal; when the image signal transmits a multiple-grayscale frame, sequentially adopting a plurality of sets of multiple-grayscale driving waveforms to drive a plurality of sub pixels of a display panel of the electrophoretic display, in which the driving voltage scales of driving waveforms corresponding to a same grayscale in the sets of multiple-grayscale driving waveforms are different from each other.

In an embodiment of the invention, the adopted sequence by the above-mentioned sets of multiple-grayscale driving waveforms is alternate forward-reverse.

In an embodiment of the invention, the adopted sequence by the above-mentioned sets of multiple-grayscale driving waveforms is cycling in sequence.

In an embodiment of the invention, the driving method of an electrophoretic display further includes: when the image signal transmits a two-grayscale frame, adopting a set of two-grayscale driving waveforms to drive the sub pixels.

Based on the depiction of the electrophoretic display and the driving method thereof of the invention, when the image signal transmits a multiple-grayscale frame, a plurality of sets of multiple-grayscale driving waveforms are sequentially adopted to drive a plurality of sub pixels of a display panel of the electrophoretic display. Since the driving voltage scales of driving waveforms corresponding to a same grayscale in the sets of multiple-grayscale driving waveforms are different from each other, the luminance of a same grayscale displayed by the sub pixels would be lightly different from each other so as to produce a dithering effect. As a result, a finer frame is displayed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system diagram of an electrophoretic display according to an embodiment of the invention.

FIGS. 2A-2G are diagrams showing the corresponding relations between the sub pixel P in the display panel 140 of FIG. 1 and the sets of driving waveforms.

FIG. 3 is a flowchart of a driving method of an electrophoretic display according to an embodiment of the invention.

### DESCRIPTION OF THE EMBODIMENTS

Reference will now be made in detail to the preferred embodiments of the invention, examples of which are illustrated in the accompanying drawings. Wherever possible, the same reference numbers are used in the drawings and the description to refer to the same or like parts.

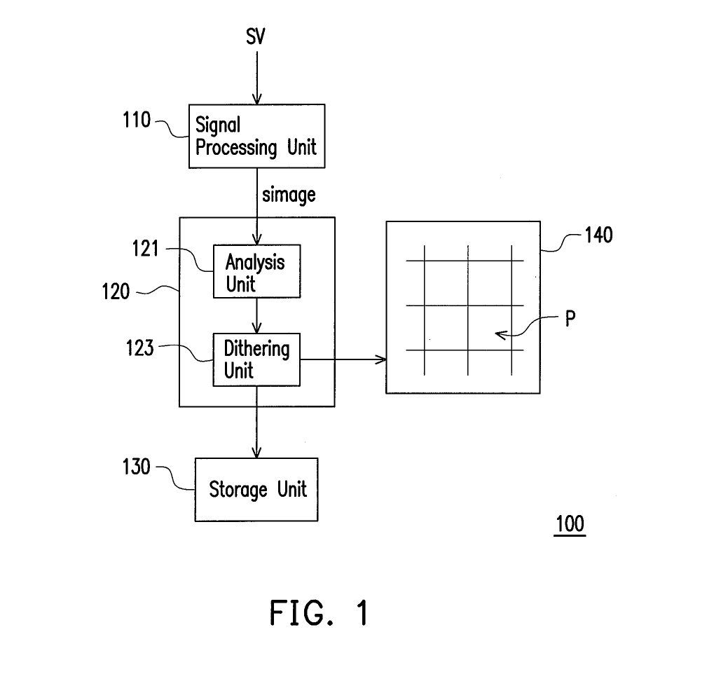

FIG. 1 is a system diagram of an electrophoretic display according to an embodiment of the invention. Referring to FIG. 1, an electrophoretic display 100 includes a signal processing unit 110, a timing controller 120, a storage unit 130 and a display panel 140. The display panel 140 has a plurality of sub pixels P. The signal processing unit 110 receives a video signal SV and produces an image signal Simage according to the video signal SV, in which the image signal Simage is for transmitting a plurality of display data of a frame.

The storage unit 130 stores a plurality of sets of multiple-grayscale driving waveforms including a set of two-grayscale driving waveforms, in which in terms of function, the storage unit 130 can be seen as a look-up table (LUT). The driving voltage scales of driving waveforms corresponding to a same grayscale in the sets of multiple-grayscale driving waveforms are different from each other, and the driving voltage scales of driving waveforms corresponding to a same grayscale in the sets of multiple-grayscale driving waveforms can be increasing or decreasing gradually, which can be defined by anyone skilled in the art himself.

The timing controller 120 is coupled to the signal processing unit 110, the storage unit 130 and the display panel 140. When the image signal Simage transmits a two-grayscale frame, the timing controller 120 would adopt a set of two-grayscale driving waveforms to drive the sub pixels P of the display panel 140; when the image signal Simage transmits a non-two-grayscale frame, the timing controller 120 would sequentially adopt the sets of multiple-grayscale driving waveforms to drive the sub pixels P of the display panel 140.

The timing controller 120 includes an analysis unit 121 and a dithering unit 123. The analysis unit 121 receives and analyzes the image signal Simage so as to judge whether or not the frame transmitted by the image signal Simage is a two-grayscale frame according to the analysis result. In more details, the analysis unit 121 would analyze the display data transmitted by the image signal Simage so as to obtain a histogram data corresponding to all the grayscale values, i.e., obtain the degree corresponding to each of the grayscale values. After summarizing the degree corresponding to the maximal grayscale value and the degree corresponding to the minimal grayscale value, the summarized result is just the analysis result. When the analysis result is greater than or equal to a threshold (for example, 100% or 95%), it can be concluded that the frame transmitted by the image signal Simage is a two-grayscale frame; otherwise, the frame transmitted by the image signal Simage is a non-two-grayscale frame. The threshold used for judging a frame can be determined by anyone skilled in the art, which the invention is not limited to.

When it is judged that the image signal Simage transmits a two-grayscale frame, the dithering unit 123 would adopt the set of two-grayscale driving waveforms to drive the sub pixels P of the display panel 140; when it is judged that the image signal Simage transmits a non-two-grayscale frame, the dithering unit 123 would sequentially adopt the sets of multiple-grayscale driving waveforms to drive the sub pixels P of the display panel 140.

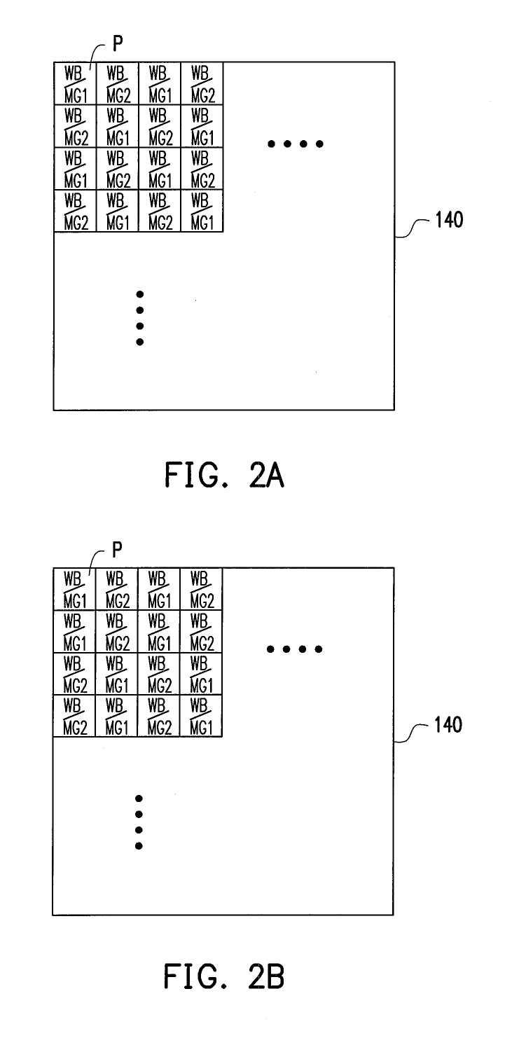

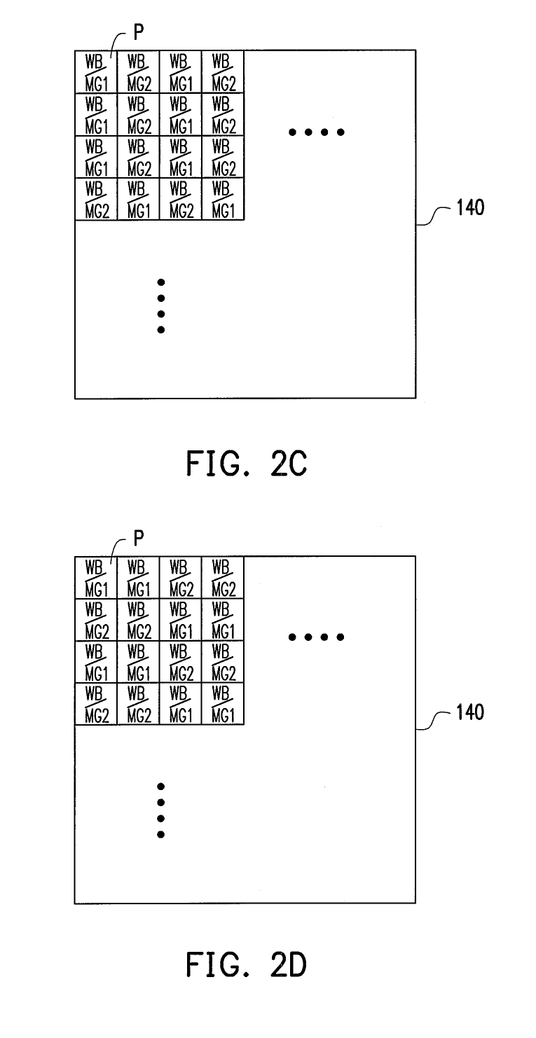

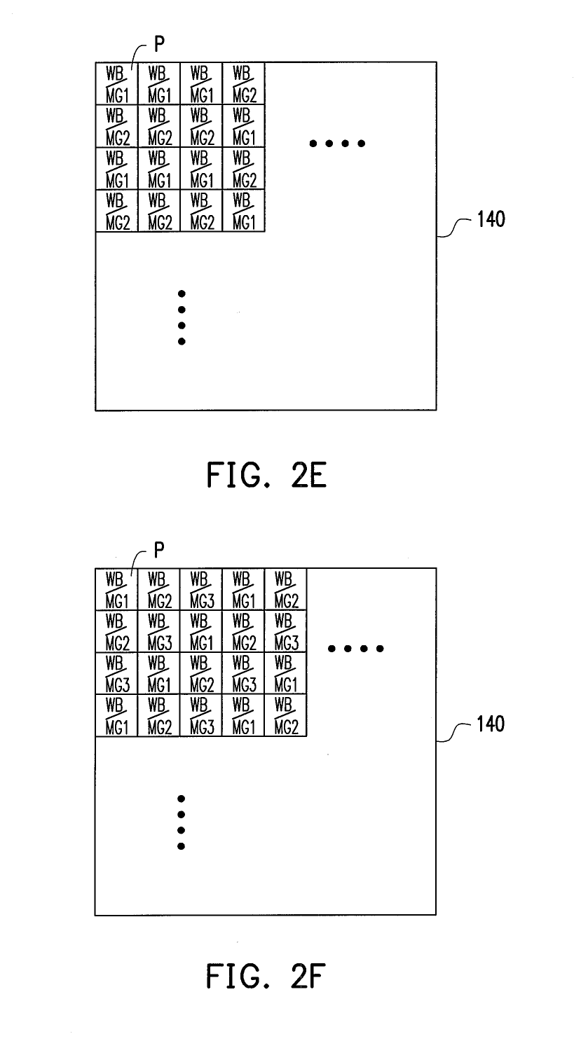

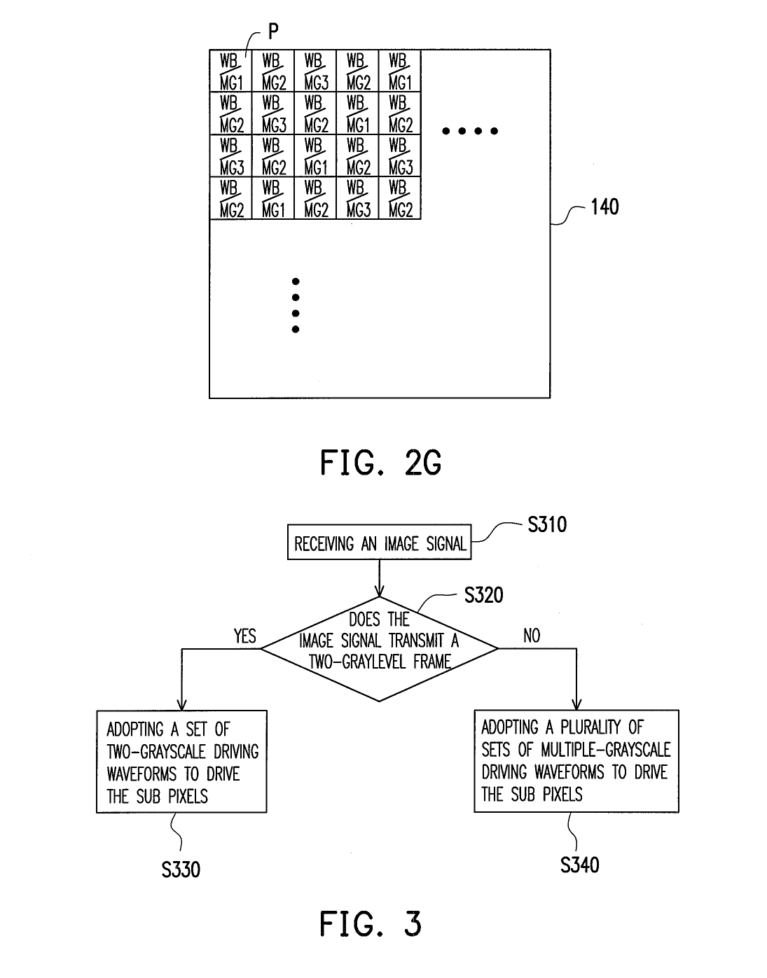

In following, it is depicted how the dithering unit 123 adopts the set of two-grayscale driving waveforms and the sets of multiple-grayscale driving waveforms to drive the sub pixels P of the display panel 140. FIGS. 2A-2G are diagrams showing the corresponding relations between the sub pixel P in the display panel 140 of FIG. 1 and the sets of driving waveforms. Referring to FIGS. 1 and 2A, assuming herein the storage unit 130 stores a set of two-grayscale driving waveforms WB and two sets of multiple-grayscale driving waveforms MG1 and MG2. The following depiction takes sequences from up to down and from left to right, which the embodiment of the invention is not limited to.

In FIG. 2A, when the image signal Simage transmits a two-grayscale frame, every sub pixel P is driven by the set of two-grayscale driving waveforms WB. When the image signal transmits a non-two-grayscale frame, the first sub pixel P of the first row in the display panel 140 is driven by the set of multiple-grayscale driving waveforms MG1, the second sub pixel P of the first row in the display panel 140 is driven by the set of multiple-grayscale driving waveforms MG2, the third sub pixel P of the first row in the display panel 140 is driven by the set of multiple-grayscale driving waveforms MG1, and analogically for the rest. Since the driving voltage scales of driving waveforms corresponding to a same grayscale in the sets of multiple-grayscale driving waveforms MG1 and MG2 are different from each other, the real luminance corresponding to a same grayscale produced by the adjacent sub pixels P would be lightly different from each other so as to produce a dithering effect, which makes the frame displayed more finely. In addition, the luminance difference between the pixels P is reduced so as to make the displayed frame more smoothly.

The first sub pixel P of the second row in the display panel 140 is driven by the set of multiple-grayscale driving waveforms MG2, the second sub pixel P of the second row in the display panel 140 is driven by the set of multiple-grayscale driving waveforms MG1, the third sub pixel P of the second row in the display panel 140 is driven by the set of multiple-grayscale driving waveforms MG2, and analogically for the rest. According to the above-mentioned operations, the corresponding relation between the sub pixels P of the second row and the sets of multiple-grayscale driving waveforms MG1 and MG2 can be seen as the corresponding relation between the sub pixels P of the first row and the sets of multiple-grayscale driving waveforms MG1 and MG2 but with left-shifting by a sub pixel P.

As shown by FIG. 2A, the corresponding relation between the sub pixels P of the third row and the sets of multiple-grayscale driving waveforms MG1 and MG2 can be seen as the corresponding relation between the sub pixels P of the second row and the sets of multiple-grayscale driving waveforms MG1 and MG2 but with left-shifting by a sub pixel P, the corresponding relation between the sub pixels P of the fourth row and the sets of multiple-grayscale driving waveforms MG1 and MG2 can be seen as the corresponding relation between the sub pixels P of the third row and the sets of multiple-grayscale driving waveforms MG1 and MG2 but with left-shifting by a sub pixel P, and analogically for the rest. In this way, each sub pixel P and the adjacent sub pixels P are respectively driven by different sets of multiple-grayscale driving waveforms (for example, MG1 and MG2) so as to produce a dithering effect, which makes the frame displayed more smoothly.

Referring to FIGS. 2A and 2B, the difference of FIG. 2B from FIG. 2A is that both the first row and the second row of the display panel 140 adopt the sets of multiple-grayscale driving waveforms MG1 and MG2 with the same sequence. The corresponding relation between the sub pixels P of the third row and the sets of multiple-grayscale driving waveforms MG1 and MG2 can be seen as the corresponding relation between the sub pixels P of the second row and the sets of multiple-grayscale driving waveforms MG1 and MG2 but with left-shifting by a sub pixel P, and both the third row and the fourth row of the display panel 140 adopt the sets of multiple-grayscale driving waveforms MG1 and MG2 with the same sequence.

According to the depiction above, the corresponding relations between the sub pixels P of every two rows and the sets of multiple-grayscale driving waveforms MG1 and MG2 are the same as the other two rows, so that, on the vertical direction, two adjacent sub pixels P are driven by a same set of multiple-grayscale driving waveforms (for example, MG1 or MG2). Since, in the display panel 140 of FIG. 2B, there are still two adjacent sub pixels P are driven respectively by different set of multiple-grayscale driving waveforms (for example, MG1 or MG2). Thus, the driving mode of FIG. 2B keeps the dithering effect.

Referring to FIGS. 2A and 2C, the difference of FIG. 2C from FIG. 2A is that the first row, the second row and the third row of the display panel 140 adopt the sets of multiple-grayscale driving waveforms MG1 and MG2 with the same sequence. The corresponding relation between the sub pixels P of the fourth row and the sets of multiple-grayscale driving waveforms MG1 and MG2 can be seen as the corresponding relation between the sub pixels P of the third row and the sets of multiple-grayscale driving waveforms MG1 and MG2 but with left-shifting by a sub pixel P. According to the depiction above, the corresponding relations between the sub pixels P of every three rows and the sets of multiple-grayscale driving waveforms MG1 and MG2 are the same, so that, on the vertical direction, three adjacent sub pixels P are driven by a same set of multiple-grayscale driving waveforms (for example, MG1 or MG2).

Referring to FIGS. 2A and 2D, the difference of FIG. 2D from FIG. 2A is that both the first and second sub pixels P of the first row in the display panel 140 are driven by the same set of multiple-grayscale driving waveforms MG1; both the third and fourth sub pixels P of the first row are driven by the same set of multiple-grayscale driving waveforms MG2. The corresponding relation between the sub pixels P of the second row and the sets of multiple-grayscale driving waveforms MG1 and MG2 can be seen as the corresponding relation between the sub pixels P of the first row and the sets of multiple-grayscale driving waveforms MG1 and MG2 but with left-shifting by two sub pixels P, and analogically for the rest. According to the depiction above, each set per two pixels in the sub pixels P of every row would be driven by a same set of multiple-grayscale driving waveforms (for example, MG1 or MG2). As a result, on the horizontal direction, two adjacent sub pixels P would be driven by a same set of multiple-grayscale driving waveforms (for example, MG1 or MG2).

Referring to FIGS. 2A and 2E, the difference of FIG. 2E from FIG. 2A is that the first, second and third sub pixels P of the first row in the display panel 140 are driven by the same set of multiple-grayscale driving waveforms MG1, and the fourth sub pixel P of the first row is driven by the set of multiple-grayscale driving waveforms MG2. The corresponding relation between the sub pixels P of the second row and the sets of multiple-grayscale driving waveforms MG1 and MG2 can be seen as the corresponding relation between the sub pixels P of the first row and the sets of multiple-grayscale driving waveforms MG1 and MG2 but with left-shifting by three sub pixels P, and analogically for the rest. According to the mention above, each set per three pixels in the sub pixels P of every row is driven by a same set of multiple-grayscale driving waveforms (for example, MG1 or MG2), so that three adjacent sub pixels P on the horizontal direction would be driven by a same set of multiple-grayscale driving waveforms (for example, MG1 or MG2).

Referring to FIGS. 2A and 2F, the storage unit 130 herein is assumed further to store a set of multiple-grayscale driving waveforms MG3. The difference of FIG. 2F from FIG. 2A is that the third sub pixel P of the first row in the display panel 140 in FIG. 2F is driven by the set of multiple-grayscale driving waveforms MG3, the fourth sub pixel P of the first row is driven by the set of multiple-grayscale driving waveforms MG1 and the fifth sub pixel P of the first row is driven by the set of multiple-grayscale driving waveforms MG2. The corresponding relation between the sub pixels P of the second row and the sets of multiple-grayscale driving waveforms MG1, MG2 and MG3 can be seen as the corresponding relation between the sub pixels P of the first row and the sets of multiple-grayscale driving waveforms MG1, MG2 and MG3 but with left-shifting by a sub pixel P, and analogically for the rest. According to the mention above, the adopted sequence of the sets of multiple-grayscale driving waveforms MG1, MG2 and MG3 to drive the sub pixels P of each row is cycling in sequence. In other words, the sub pixels P of each row are driven through cycling in sequence of the sets of multiple-grayscale driving waveforms MG1, MG2 and MG3.

Referring to FIGS. 2F and 2G, the difference of FIG. 2G from FIG. 2F is that the fourth sub pixel P of the first row in the display panel 140 of FIG. 2G is driven by the set of multiple-grayscale driving waveforms MG2, the fifth sub pixel P of the first row is driven by the set of multiple-grayscale driving waveforms MG1. The corresponding relation between the sub pixels P of the second row and the sets of multiple-grayscale driving waveforms MG1, MG2 and MG3 can be seen as the corresponding relation between the sub pixels P of the first row and the sets of multiple-grayscale driving waveforms MG1, MG2 and MG3 but with left-shifting by a sub pixel P, and analogically for the rest. According to the mention above, the adopted sequence of the sets of multiple-grayscale driving waveforms MG1, MG2 and MG3 to drive the sub pixels P of each row is alternate forward-reverse. In other words, the sub pixels P of each row are driven firstly in the sequence of the sets of multiple-grayscale driving waveforms MG1, MG2 and MG3 and then in the sequence of the sets of multiple-grayscale driving waveforms MG3, MG2 and MG1, and analogically for the rest.

It should be noted that the corresponding relations between the sub pixels P in the display panel 140 and the sets of multiple-grayscale driving waveforms In FIGS. 2A-2G are a part of the embodiments. In fact, more embodiments can be deducted from the depiction above, which is omitted to describe. The number used by the above-mentioned embodiments can be changed according to the requirement of anyone skilled in the art, which the invention is not limited to. For example, it is allowed that, for example, four adjacent sub pixels P in the sub pixels P of every row are driven by a same set of multiple-grayscale driving waveforms, or the sub pixels P of every four rows take a same sequence to adopt the sets of multiple-grayscale driving waveforms.

A driving method applicable to the electrophoretic display 100 can be summarized according to the depiction above. FIG. 3 is a flowchart of a driving method of an electrophoretic display according to an embodiment of the invention. Referring to FIG. 3, in the embodiment, firstly, an image signal is received (step S310). When the image signal transmits a two-grayscale frame (step S320), a set of two-grayscale driving waveforms is adopted to drive the sub pixels (step S330). When the image signal transmits a non-two-grayscale frame (step S320), a plurality of sets of multiple-grayscale driving waveforms are sequentially adopted to drive the sub pixels (step S340). The driving voltage scales of driving waveforms corresponding to a same grayscale in the sets of multiple-grayscale driving waveforms are different from each other. The details of the steps can refer to the depiction above, which is omitted to describe.

In summary, the embodiments of the invention provide the electrophoretic display and the driving method thereof. When the image signal transmits a non-two-grayscale frame, a plurality of sets of multiple-grayscale driving waveforms are sequentially adopted to drive a plurality of sub pixels of the display panel. Since the driving voltage scales of driving waveforms corresponding to a same grayscale in the sets of multiple-grayscale driving waveforms are different from each other, the luminance of a same grayscale displayed by the sub pixels would be lightly different from each other so as to produce a dithering effect and a finer frame. In addition, the luminance difference between the above-mentioned pixels is reduced so that the displayed frame looks more smoothly.

It will be apparent to those skilled in the art that the descriptions above are several preferred embodiments of the invention only, which does not limit the implementing range of the invention. Various modifications and variations can be made to the structure of the invention without departing from the scope or spirit of the invention.

What is claimed is:

1. An electrophoretic display, comprising:
a display panel, having a plurality of sub pixels;
a storage unit, storing a plurality of sets of multiple-grayscale driving waveforms, wherein the driving voltage scales of driving waveforms corresponding to a same grayscale in the sets of multiple-grayscale driving waveforms are different from each other; and
a timing controller, coupled to the storage unit and the display panel and receiving an image signal, wherein when the image signal transmits a multiple- grayscale frame, the timing controller sequentially adopts the sets of multiple-grayscale driving waveforms to drive the sub pixels.

2. The electrophoretic display as claimed in claim 1, wherein the sequence for the timing controller to adopt the sets of multiple-grayscale driving waveforms is alternate forward-reverse.

3. The electrophoretic display as claimed in claim 1, wherein the sequence for the timing controller to adopt the sets of multiple-grayscale driving waveforms is cycling in sequence.

4. The electrophoretic display as claimed in claim 1, wherein a plurality of sub pixels adjacent to each other along a first direction in the sub pixels are driven by using a same set of multiple-grayscale driving waveforms.

5. The electrophoretic display as claimed in claim 4, wherein the first direction is a vertical direction.

6. The electrophoretic display as claimed in claim 4, wherein the first direction is a horizontal direction.

7. The electrophoretic display as claimed in claim 1, wherein each of the sub pixels and the adjacent sub pixels are driven by using different sets of multiple-grayscale driving waveforms.

8. The electrophoretic display as claimed in claim 1, wherein the timing controller comprises:
an analysis unit, receiving the image signal for judging whether or not the image signal transmits a multiple-grayscale frame; and
a dithering unit, coupled to the analysis unit, wherein when the image signal transmits a multiple-grayscale frame, the dithering unit sequentially adopts the sets of multiple-grayscale driving waveforms to drive the sub pixels.

9. The electrophoretic display as claimed in claim 1, wherein when the image signal transmits a two-grayscale frame, the timing controller adopts a set of two-grayscale driving waveforms stored in the storage unit to drive the sub pixels.

10. The electrophoretic display as claimed in claim 1, further comprising:
a signal processing unit, coupled to the timing controller and receiving a video signal so as to produce the image signal according to the video signal.

11. A driving method of an electrophoretic display, comprising:
receiving an image signal; and
when the image signal transmits a multiple-grayscale frame, sequentially adopting a plurality of sets of multiple-grayscale driving waveforms to drive a plurality of sub pixels of a display panel of the electrophoretic display, wherein the driving voltage scales of driving waveforms corresponding to a same grayscale in the sets of multiple-grayscale driving waveforms are different from each other.

12. The driving method of an electrophoretic display as claimed in claim 11, wherein the adopted sequence by the sets of multiple-grayscale driving waveforms is alternate forward-reverse.

13. The driving method of an electrophoretic display as claimed in claim 11, wherein the adopted sequence by the sets of multiple-grayscale driving waveforms is cycling in sequence.

14. The driving method of an electrophoretic display as claimed in claim 11, further comprising:
when the image signal transmits a two-grayscale frame, adopting a set of two-grayscale driving waveforms to drive the sub pixels.
